(19) United States
(12) Patent Application Publication
(10) Pub. No.: US 2010/0073461 A1
(43) Pub. Date: Mar. 25, 2010

(54) Lighting unit and method for the generation of an irregular pattern

(75) Inventors: Markus Hammes, Freiburg (DE); Stephan Schmitz, Freiburg (DE); Shane MacNamara, Ebringen (DE); Martin Collischon, Stein (DE)

Correspondence Address: THE NATH LAW GROUP, 112 South West Street, Alexandria, VA, 22314, US

(73) Assignee: SICK AG, Waldkirch (DE)

(21) Appl. No.: 12/585,625

(22) Filed: Sep. 18, 2009

(30) Foreign Application Priority Data
Sep. 23, 2008 (EP) 08105416.5

(51) Int. Cl. H04N 13/00; H01S 3/13

(52) U.S. Cl. 348/42; 372/29.016; 348/E13.001

(57) ABSTRACT

A lighting unit (100) having a divergent coherent light source (104, 106) is provided for the generation of an at least locally irregular pattern (20) in a monitored zone (12). In this respect, the lighting unit (100) has an optical phase element (108, 110) in the beam path of the light source (104, 106), said optical phase element having unevenness made to generate local phase differences between light portions incident at the phase element at adjacent positions and thus to generate the irregular pattern (20) by interference.

The invention relates to a lighting unit and to a method for the illumination of a monitored zone having an irregular pattern in accordance with the preamble of claim 1 and claim 12 respectively.

Cameras have been used for monitoring for a long time and are increasingly also used in safety technology. A typical application in safety technology is the securing of a dangerous machine such as a press or a robot where a securing takes place around the machine on intrusion of a body part into a danger area. Depending on the situation, this can be the switching off of the machine or the bringing into a safe position.

If the scene to be monitored is of low contrast or if it has regions with little structure, the recognition of incidents critical to safety is thereby made more difficult or even prevented. This applies to a very particular degree to three-dimensional monitoring processes based on stereoscopy. In this respect, images of the scene are gained from slightly different perspectives. Structures which are the same are identified in the overlapping image regions and distances are calculated from the disparity and the optical parameters of the camera system by means of triangulation and thus a three-dimensional image or a depth map is calculated.

Stereo camera systems offer the advantage with respect to conventional safety-technology sensors such as scanners and light grids of determining depth information over the total area from an observation scene taken two-dimensionally. Protected zones can be specified more variably and more precisely with the help of the depth information in safety-technical applications and more and more precise classes of permitted object movements can be distinguished, that is, for example, movements of the robot itself or movements of q body part past the dangerous machine in a different depth plane which is completely safe per se, but cannot be differentiated by a two-dimensional camera. However, within safety technology, for a reliable safety function beyond the secure recognition of an intrusion in the provided image data, there is the additional demand of generating these three-dimensional image data in the form of a dense depth map, that is of having a reliable distance value available for each image region and preferably for almost every picture element.

Large structure-less areas or structural features similar to one another can prevent a clear association of image areas on the location of correspondences between the structural elements of the images. In this respect, at least two types of error are conceivable, namely a failure of the location of mutually corresponding structural elements or an erroneous association. The consequences are gaps in the three-dimensional images or erroneous calculations of the distances. Both are extremely dangerous for safety-technical applications since an unpermitted intrusion could remain unrecognized or an incorrect distance could be associated. The switching off of the danger source is then possibly not carried out because the intrusion is erroneously classed as non-critical.

Passive stereo measurement systems which carry out their distance measurement solely on the basis of the features naturally present in the images and which accordingly have no influence on the quality and the density of these features therefore do not allow any reliable safety function. A possible structural weakness or low contrast is accompanied here simply by a lack of brightness as a possible error source. It is naturally possible for a preset application to select or prepare the scene correspondingly, but this is complex and creates additional dependencies.

Active stereo measurement systems essentially use, in addition to the reception system, two mutually calibrated cameras, a lighting unit whose function it is to illuminate the observed scene with structured light and so to generate features due to the numerous light/dark transitions in the images and by reference to said features the stereo algorithm can extract reliable and dense spacing data from the scene. Such patterns can naturally also be irregular, that is primarily not have any regions mutually symmetrical with respect to shifts for the present monitoring process.

Conventionally, lighting units are proposed having projection techniques similar to a transparency projector or on the basis of diffractive optical elements (DOEs) as sample generators. Projectors have the disadvantage that the pattern generation is basically a selection process of the radiated light wherein an intermediate image of a transparency is imaged in the form of a transparency via an objective into the outside space or observation space. The light yield is thereby very poor at approximately 30%. This is particularly problematic because the semiconductor light sources preferably used due to their narrow band nature and long service life with respect to halogen lamps, for instance, anyway per se hardly reach the required optical output powers for more than the shortest ranges. In addition, the pattern in the external space is only focused in one plane and blurs more or less fast in front of this in dependence on the speed of the imaging objective. Since the distances in dynamic scenes are not known in advance, it is not possible to specify a single required focused imaging plane. Finally, the effort with respect to the optical system, for example the imaging objectives, the condenser lenses, homogenizations and the like as well also with respect to the electronics, for example, the control of the light source or the cooling, is very high and a projector solution is therefore very cost-intensive.

Lighting units on the basis of DOEs have much higher light yields. However, they need properly collimated laser light and, in the zeroth order, always transmit a portion to the order of around 1% of the incident light without diffraction. A still very pronouncedly bundled beam therefore exits the lighting unit and no solutions are necessary to remove this beam easily from the illuminated field again. Such lighting units are thus either not able to satisfy demands on eye safety or the laser protection class and are thus not permitted for operation or one has to manage with very little useful light so that the beam transmitted without diffraction remains uncritical for eye safety. However, such little useful light does not allow any generation of dense depth maps with stereo algorithms over more than very short ranges.

It is known from EP 1 543 270 B1 to satisfy safety-technical applications with a three-dimensional stereo camera. In this connection, two different stereo algorithms are used, namely a contour-based and a correction-based scene analysis. The system is passive and accordingly works solely with the ambient light. This weakness of the system has an effect on both stereo processes used which can therefore also necessarily not be compensated with respect to the disadvantages of passive systems described above.

In US 2007-0263903 A1, a stereo camera system generates a structured illumination pattern by means of a lighting unit and said structured illumination is then used to calculate distances. In this respect, the pattern arises in that a diffractive optical element is illuminated using a laser or an LED. The problem with eye safety discussed above is addressed just as little here as safety-technical applications. Conventional lighting devices of this type, however, have a comparatively small optical output power of less than one watt and the transmitted beam in the zeroth diffraction order is therefore less critical. The arising brightness values are also generally sufficient in non-safety-technical applications because occasional errors in the distance calculation or partial regions for which temporarily no distance data can be calculated do not have any serious consequences. In another respect, there is always the possibility of increasing the exposure time and thus of compensating ranges of the active illumination which are too low. This is not possible in safety engineering because a plurality of complete depth maps have to be present in every very short response period to ensure a reliable evaluation with comparisons and multiple security.

It is therefore the object of the invention to provide a lighting unit for the generation of a structured pattern which can be used cost-effectively and reliably. High effective optical output powers should also be achievable in this respect.

This object is satisfied by a lighting unit and a method for the illumination of a monitored zone having an irregular pattern in accordance with claim 1 and claim 12 respectively. This pattern is irregular at least locally, i.e. pattern structures are repeated at the earliest at a specific interval or outside an environment. This environment is preset in the case of use of the lighting unit with a stereo sensor by that environment within which the stereo algorithm looks for correspondences in the two images.

In this respect, the solution in accordance with the invention starts from the principle of utilizing the coherence of light as pattern generating. The coherence effects utilized in accordance with the invention are customarily considered as disturbing and are suppressed as much as possible. Furthermore, almost the total light of the light source is utilized in that only the phases are changed and the light is otherwise incident into the monitored zone largely without impediment.

Numerous advantages are associated with this. With an extremely good light yield, which can be almost at 90% and which permits high sensor ranges due to high energies in the pattern elements, no problems with eye safety arise due to the divergent light since there is no bundled light beam at all. Because the underlying effect is far field interference, the pattern has a very high depth of field and is thus not fixed to an individual monitored plane. The contrast is high. The light is of a narrow band; the useful light can therefore easily be filtered out of the ambient light. The lighting unit can be controlled flexibly and can generate flexible patterns. In this respect, it is very compact, cost-effective and has a long life.

The unevenness is advantageously provided at least over the total region of the phase element illuminated by the light source and/or the phase element has no smooth partial regions. Phase differences and thus interference patterns thus arise everywhere in the relevant monitored zone. Gaps or low-contrast regions are prevented and the basis is provided for a full-area monitoring or for a dense depth map.

The unevenness is preferably irregular and very small with respect to the geometrical extent of the phase element, in particular its thickness, with the unevenness varying over the phase element and/or with the unevenness being provided on one or more surfaces of the phase element. The unevenness only has to generate phase differences in the range of the wavelengths of the light used, for which purposes very small thickness differences suffice. The unevenness should preferably vary over the phase element to prevent local and global regularities of the pattern generated. It is basically sufficient already to generate the phase differences on an area or surface of the phase element; however, further surfaces can also have unevenness, with this naturally only being optically active when ii is in the area of light incidence. Unevenness caused by production can already be sufficient in that a smoothing step of the optically active surfaces is omitted. The phase element is then particularly cost-effective. The unevenness can, however, also be applied actively.

The phase element advantageously has transmissive or reflective properties, is in particular a phase plate or a phase mirror, and/or the phase element has additional beam-shaping properties, is in particular made as a lens or as a concave mirror. Depending on the desired beam path, a mirror or a plate is more suitable. If additional imaging properties are desired, for instance for the further restriction of the illuminated field, it is possible to integrate the required beam-shaping properties into the phase element and thus to make an additional optical element dispensable.

At least one further optical element, in particular a prism, a plate, a lens or a mirror, is preferably arranged in the optical beam path of the phase element, with the further element being made as a further phase element in particular by means of unevenness and/or with a diaphragm or an additional optical element, in particular a cylindrical lens, being provided to specify the region illuminated by the pattern. Patterns and the illuminated field can thus be equipped with further desired properties. Such additional elements should be dispensable by a suitable design of the phase element. In some applications, however, the division of desired optical properties over a plurality of elements is more favorable, for example, to be able to use existing or standardized elements.

The phase element preferably comprises glass or plastic, is in particular a glass plate, a molded plastic part or a film, with the phase element again preferably being coated on at least one surface or comprising a film, with the coating, the film or their connection region with the phase element comprising the unevenness producing the local phase differences. This coating or the film can have a microstructure. An extremely cost-effective phase element can be manufactured as a glass plate or as a film. The required unevenness can be produced easily in these materials and, where required, additionally or alternatively as a film.

The light source is preferably a laser, with an optical distribution system which can make the laser light divergent being provided between the laser and the phase element. This optical distribution system can simultaneously be utilized for the setting of the illumination angle. Due to the low performance losses in the phase element, moderate light powers are sufficient or higher ranges than normally can be achieved with high power lasers.

In a further development of the invention, a plurality of lighting units are provided for the generation of an irregular pattern in a larger illuminated region or with a larger illumination intensity, with the illuminated regions of the individual lighting units being added together in an overlapping or non-overlapping manner. The lighting units can generate a larger illuminated region in a tile-like manner in the one alternative. The arrangement has the advantage that the light energies deposed in the monitored zone are added together without attenuating pattern edges due to overlaps. As with a plurality of lighting units with overlapping illuminated fields, multi-emitter laser diodes which are usually used for high output powers are also not sufficient means because in this process a plurality of patterns are superimposed on one another and thus lower the contrast. Since it is therefore not possible to increase the light power incident over the total monitored zone as desired, provision is made in this embodiment to increase the power density by smaller illuminated fields and to achieve the desired size of the monitored zone by a plurality of lighting modules. It is conceivable in this respect in each case to utilize the same phase element of all or of a plurality of light sources provided that it is large enough so that the named disturbing effects of the light sources among one another are sufficiently suppressed. In the other alternative, identical or non-random patters are superimposed so that the required illumination intensity is only achieved in the common superimposition to satisfy the demands on the eye protections with every single lighting source and thus also overall.

The illumination camera in accordance with the invention is preferably used in a safety camera, in particular in a 3D stereo safety camera. Safety technology is particularly demanding and a safety camera can satisfy its job better if sufficient contrast is ensured in the monitored zone. A combination with stereo safety applications is particularly advantageous because the pattern allows the generation of dense depth maps independently of the ambient light and of the object structures in the monitored zone.

An evaluation unit is preferably provided in such a safety camera which is made for the use of a stereo algorithm in which mutually associated sub-regions of the images taken by the two cameras of the stereo camera are recognized and their distance is calculated with reference to the disparity, and with the evaluation unit in particular furthermore being made to recognize unpermitted intrusions into the monitored zone and thereupon to generator a switch-off signal. The stereo algorithm implemented in this manner profits from the fact that correspondences can be clearly determined with reference to the illumination structure. An unpermitted intrusion means that, on the one hand, an intrusion is recognized and, on the other hand, this intrusion does not correspond to any previously learned or algorithmically recognized permitted movement object, to any permitted movement or the like.

In this respect, a safety output is again preferred via which the safety camera can output a switch-off signal to a monitored machine. A recognized unpermitted intrusion can thus result in an elimination of the danger in a safe manner. It is conceivable in this respect to precede the switching off with a warning, that is, for example, to define protected fields in which a switching off should take place, and warning fields disposed in front in which an alarm, for example a visual or an acoustic alarm, is first triggered to still prevent the intrusion resulting in the switching off if possible due to the warning.

The method in accordance with the invention can be further developed in a similar manner and shows similar advantages. Such advantageous features are described in an exemplary, but not exclusive, manner in the subordinate claims dependent on the independent claims.

In the method in accordance with the invention, the structural size of the pattern is preferably set by the distance between a source of the divergent coherent light and the phase element and/or the illuminated region is set by means of diaphragms or further optical elements and/or a plurality of sources for divergent coherent light are used to generate a larger illuminated region. A high flexibility is thus provided for the desired pattern, which ultimately determines the resolution of a sensor using the pattern, for its range and illuminated field.

In a stereoscopic image detection process, the monitored zone is preferably illuminated by the illumination method in accordance with the invention for the generation of a dense depth map of a scene. The particularly irregular pattern resolves ambiguities in the scene by non-ambiguity in the pattern. The stereo algorithm can thus associate a distance value with each sub-region of the monitored zone independently of the present structure or of the ambient light.

In a method for the safe three-dimensional monitoring of a spatial zone, a dense depth map generated using an image detection method in accordance with the invention is preferably evaluated for unpermitted intrusions and, if an unpermitted intrusion is recognized, a switch-off signal is output to a danger source. The dense depth map permits a reliable safety-technical three-dimensional monitoring independent of the scene and of the ambient light.

The invention will be explained in more detail in the following also with respect to further features and advantages by way of example with reference to embodiments and to the enclosed drawing. The Figures of the drawing show in:

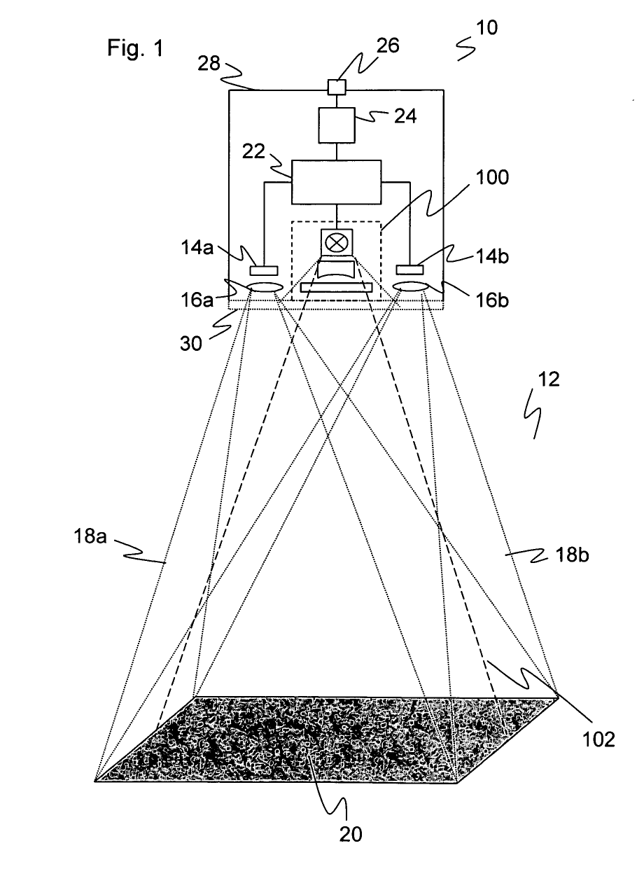

FIG. 1 a schematic spatial total representation of an embodiment of a lighting unit in accordance with the invention which illuminates a spatial zone with a structured pattern in a 3D safety camera;

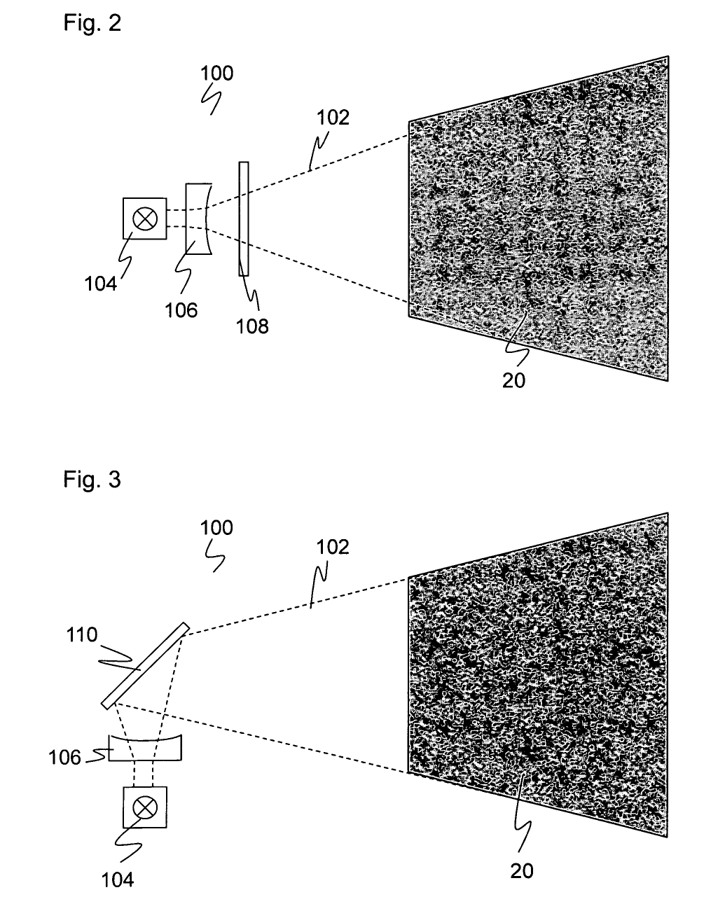

FIG. 2 a schematic representation of an embodiment of the lighting unit in accordance with the invention with a phase plate;

FIG. 3 a representation in accordance with FIG. 2 of a further embodiment of the lighting unit in accordance with the invention with a phase mirror;

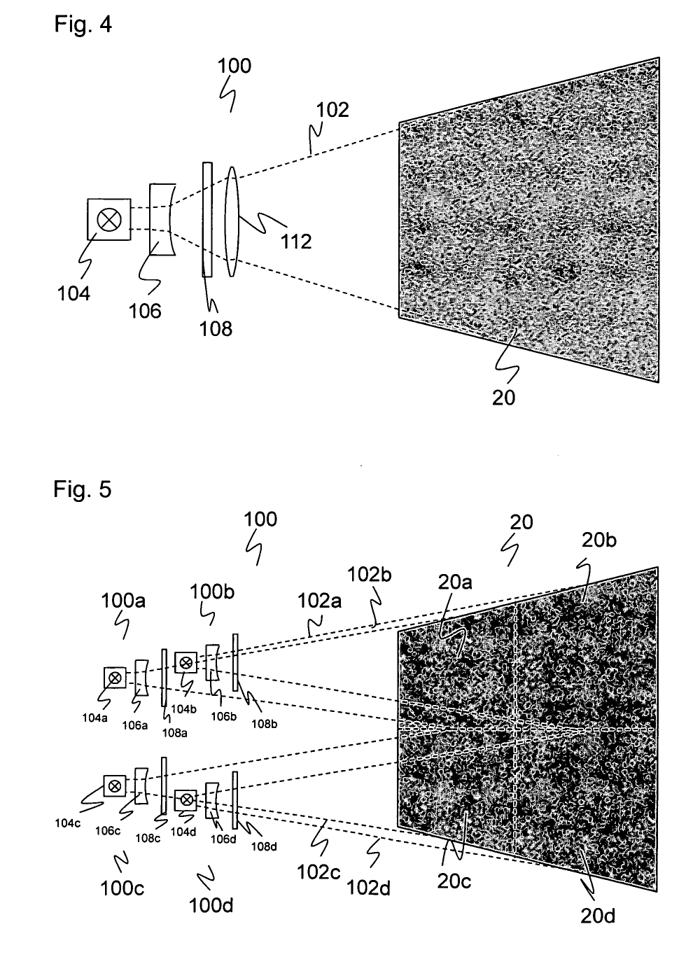

FIG. 4 a schematic representation in accordance with FIG. 2 of a further embodiment of the lighting unit in accordance with the invention with a phase plate and a further, downstream, optical element; and

FIG. 5 a representation of an arrangement of a plurality of lighting units in accordance with the invention.

FIG. 1 shows in a schematic three-dimensional representation the general structure of 3D safety camera 10 in accordance with the invention in accordance with the stereo principle which is used for the safety-technical monitoring of a spatial zone 12. Two camera modules are mounted at a known fixed distance from one another and each take images of the spatial zone 12. An image sensor 14a, 14b, usually a matrix-type imaging chip, is provided in each camera and takes a rectangular pixel image, for example a CCD or a CMOS sensor. An objective is associated with the image sensors 14a, 14b and has an optical imaging system which is shown as lenses 16a, 16b and which can be realized as any known optical imaging system in practice. The viewing angle of these optical systems is shown in FIG. 1 by dashed lines which each form a pyramid of view 18a, 18b.

A lighting unit 100 is shown at the center between the two image sensors 14a, 14b, with this spatial arrangement only to be understood as an example and with the lighting unit equally being able to be arranged asymmetrically or even outside the safety camera 3D. The lighting unit 100 in accordance with the invention generates a structured illumination pattern 20 in the spatial zone 12 in an illuminated region 102 and will be explained in more detail further below in different embodiments in connection with FIGS. 2-5.

A control 22 is associated with the two image sensors 14a, 14b and the lighting unit 100. The structured illumination pattern 20 is generated by means of the control 22 and its structure or intensity is varied as required, and the control 22 receives image data of the image sensors 14a, 14b. The control 22 calculates three-dimensional image data (distance image, depth map) of the spatial zone 12 from these image data with the help of a stereo disparity estimate. The structured illumination pattern 20 in this respect provides a good contrast and an unambiguously associable structure of every image element in the illuminated spatial zone 12. It is irregular, with the most important aspect of the irregularity being the at least local, better global, lack of translation symmetries so that no apparent shifts of picture elements due to the same illumination pattern elements in the images respectively taken from different perspectives are recognized which would cause errors in the disparity estimate.

In this respect, a known problem occurs with two image sensors 14a, 14b that structures along the epipolar line cannot be used for the disparity estimate because no triangulation angle occurs here or, expressed differently, the system cannot distinguish locally whether the structure in the two images is taken in a displaced manner with respect to one another due to the perspective or whether only a non-indistinguishable other part of the same structure aligned parallel to the base of the stereo system is compared. To solve this, one or more further camera modules can be used in different embodiments which are arranged offset with respect to the straight connecting lines of the original two camera modules.

Known and unexpected objects can be located in the spatial zone 12 monitored by the safety sensor 10. This can, in this respect, be a robot arm, a machine, an operator, etc., for example. The spatial zone 12 provides access to a danger source, whether because it is an access zone or because a dangerous machine is located in the spatial zone 12 itself. To secure this danger source, one or more virtual protected fields and warning fields can be configured. It is possible on the basis of the three-dimensional evaluation likewise to define these fields three-dimensionally so that a large flexibility arises. The control 22 evaluates the three-dimensional image data for unpermitted intrusions. The evaluation rules can prescribe, for example, that no object at all may be present in protected fields. More flexible evaluation rules provide differentiating between allowed and non-allowed objects, for instance with reference to movement orbits, patterns or contours, speeds or general work routines which are both taught in advance as allowed and estimated during operation with reference to evaluations, heuristics or classifications.

If the control 22 recognizes an unpermitted intrusion into a protected field, a warning is output via a warning or switching-off device 24, which can in turn be integrated into the control 22, or the danger source is secured, for example a robot arm or another machine is stopped. Safety-relevant signals, that is above all the switch-off signal, are output via a safety output 26 (OSSD, output signal switching device). In this respect, it depends on the application whether a warning is sufficient or a two-stage security is provided in which a warning is initially given and a switching off is only carried out on a continued object intrusion or an even deeper penetration. Instead of a switching off, the appropriate reaction can also be the immediate bringing into a non-dangerous parked position.

The sensor 10 is designed as failsafe to be suitable for safety-technical applications. This means, among other things, that the sensor 10 can test itself in cycles below the required response time, in particular also recognizes defects of the lighting unit 100 and thus ensures that the illumination pattern 20 is available in an expected minimum intensity and that the safety output 26 and the warning or switching off device 24 are made safe, for example with two channels. The control 22 is equally also self-reliant that is evaluates with two channels or uses algorithms which can test themselves. Such regulations are standardized for generally contactlessly acting protective devices in EN 61496-1 or in IEC-61406. A corresponding standard for safety cameras is under preparation.

The safety camera 10 is surrounded and protected by a housing 28. Light can pass into and out of the spatial zone 12 through a front window 30. The front window 30 has filter properties which are matched to the transmission frequency of the lighting unit 100. Even with fast lighting units 100, the useful signal cannot be sufficiently detected in the noise of the total spectrum, namely under unfavorable conditions such as very bright environments, large monitoring volumes or large distances of 5 meters and more. With a lighting unit 100 which only transmits light in one or more narrow visible, ultraviolet or infrared bands and with a filter 30 matched thereto, the signal-to-noise ratio can be improved quite considerably because ambient light outside these bands no longer plays any role. The optical filter 30 can also be realized differently, for instance in the objectives of the camera modules.

FIG. 2 shows a first embodiment of the lighting unit 100 in accordance with the invention. As in the total description, the same reference numerals designate the same features. A light source 104 generates coherent light which is incident in unbundled form onto an optical distribution system 106 which is here shown by way of example as a diffuser lens. The light source 104 and the optical distribution system 106 thus together form a source for divergent, coherent light. It is conceivable to dispense with the optical distribution system 106 when the scattering angle of the light source 104 is sufficient as the illumination angle, that is primarily for small angles of view of the safety camera 10.

The divergent, coherent light is incident onto a pattern generating phase element made as a phase plate 108 in the embodiment shown. In the embodiment in accordance with FIG. 2, it is a simple, thin glass plate whose one surface or whose both surfaces has/have a slightly uneven topology. Due to the local thickness differences of the glass, local phase shifts of the light waves passing through occur and therefore the interference pattern which forms the structured illumination pattern 20 is formed at a larger distance from the phase plate 108. The interference pattern is highly modulated with good spatial coherence of the light source 104 and a suitable surface structure of the phase plate 108 so that a full-area illumination pattern 20 of easily visible and irregular light/dark transitions arises. The good coherence results in high contrasts of the pattern and only small homogeneous background light. With poor coherence or overlapping, independent patterns, for instance due to a plurality of light source points, the contrast is considerably attenuated. The stereo algorithm can be impaired thereby and the safety camera 10 is less robust with respect to extraneous light.

In the lighting unit 100, the light source 104 illuminates the phase element 108 from a short distance with divergent, preferably very divergent, light. Unlike, for example, in solutions with a DOE for the pattern generation, there is therefore no bundled beam which would cause problems with eye protection. The divergence of the light field additionally results in a distance-dependent curvature of the wavefront and thus in a setting possibility of the structural sizes of the interference pattern over the distance between the light source 104 or the optical distribution system 106 and the phase element 108. If, for example, the phase element 108 is displaced to a slightly larger distance, the pattern structures in the far field, that is in the spatial zone 12, are reduced and vice versa.

Since the effect arising by the phase element 108 is far field interference, the depth of field of the illumination pattern 20 is very large. Unlike, for instance, with a conventional projection process, no plane is therefore preferred in the spatial zone 12 and the illumination is thus a lot more flexible.

The coherent light source 104 is preferably a laser diode, again preferably a single emitter laser, because a plurality of source points form further interference sources and would thus cause contrast losses in the pattern. Due to the high light yield in the phase element 108, comparatively moderate output powers suffice; however, the most powerful available high-performance lasers can also be used particularly for larger ranges.

The phase element 108 shows unevenness at least over those regions in which the structured illumination pattern 20 should arise. Smooth partial regions prevent interference and thus provide pattern-free points which are at least unwanted in most applications because they can result in gaps in the depth maps. A simple realization is that the unevenness is made at one side or at both sides over the total surface of the phase element 108 or at least over the optically active surface. The unevenness should still be irregular because otherwise interference structures similar to one another could arise in the illumination pattern 20.

The phase element 108 can also be made of a different transparent material than glass, for instance comprise plastic or be made as a film. The unevenness can already only be the production tolerances of non-smoothed surfaces or they are applied separately. Coatings or coating films can be applied so that particularly a connection considered insufficiently uneven, considered exactly, in usual optical applications provides the required unevenness. A coating with corresponding unevenness is also conceivable, even in the form of microstructures. Particularly the latter is, however, a very high additional effort and the phase element 108 also shows the desired effects with much simpler caused unevenness. Plastics with any desired unevenness can be manufactured, for example, by injection molding processes.

The pattern properties can be specified more exactly in that the surface structure of the phase element is preset precisely. For example, defined structures can be determined in simulation calculations and then be generated by means of laser lithography. The structure generated in this manner can be replicated by stamping, molding with optical polymers or by precision injection molding.

The filling factor of the illuminated surface of the phase element 108, that is the portion of structural elements, should be approximately at 50% or higher for a good contrast and efficiency. The structural elements themselves are preferably anisotropic to limit isotropes in the illumination pattern 20 and thus to limit the risk of ambiguities. The structural elements can moreover be made such that the optical performance is distributed over the illuminated region 102 in a preset or ideal manner, for example compensate a marginal darkening given, for instance, by the geometries or objective influences.

FIG. 3 shows a further embodiment of the invention in which a phase mirror 110 is provided as the phase element. The local phase differences are here generated, in contrast to the example of FIG. 2, in reflection instead of in transmission, in that the mirror surface bears corresponding unevenness. The further properties and variation possibilities are analog to a phase plate. Mixed shapes with more complicated optical elements are also conceivable as the phase element, for example prisms and the like, which can selectively have transmissive or reflective properties or even both.

In a further embodiment in accordance with FIG. 4, an imaging optical element or a lens 112 is provided after the phase element 108. The near field interference shortly before or after the phase element 108 can thus be imaged into the spatial zone 12 in addition to the far field interference pattern. There is then higher flexibility in the patterns, but in turn a larger effort, namely in the provision of the optical imaging system 112, a smaller light yield and a depth of field reduced to that of the optical imaging system 112.

Instead of the optical imaging system 112, additional and/or other optical elements are possible at different points in the optical path and behind the phase element 108. An element can thus be provided for the change of the natural illuminated field of the lighting device 100 and of the light source 104, for example a cylindrical lens, or a diaphragm for the limiting of the illuminated field. Such elements can be adjusted to achieve the desired illuminated field.

These optical elements can likewise have unevenness on their surfaces to generate or amplify the pattern-generating phase differences. Furthermore, a beam-shaping optical element and the phase element 108 can also be made as integral, for example as a lens made with uneven surfaces or as a concave mirror. The front window 30 can simultaneously be made as a phase plate 108.

FIG. 5 shows a multiple arrangement of lighting modules 100a-d which form the lighting unit 100 in their totality and their structured illumination patterns 20a-d add up to a larger illumination pattern 20. This should preferably take place free of overlapping since illumination patterns 20a-d diaphragmed over one another result in contrast attenuations.

Every individual illumination module 100a-d each has a coherent light source 104a-d, an optional optical distribution system 106 for the improvement of the beam expansion for divergent light as well as a phase plate 108. Since the respective power of a separate light source 104a-d is available to every sub-region 20a-d, the total energy in the illumination pattern 20 is increased with respect to a single light source 104 of the same construction. Higher performances, that is in particular higher ranges, can thus be achieved or more cost-effective and simpler light sources of lower output power can suffice. Finally, the distribution of the light power over a plurality of sources simplifies any problems with eye protection limits even more.

Instead of the phase plate 108, other phase elements can also be used such as have previously been described with respect to the other embodiments. It is also conceivable that the lighting modules 100a-d are made differently from one another, for example in part with phase plates 108 and in part with phase mirrors 110, for instance to utilize the construction space better. The described further optical elements can also be provided in some or all lighting modules 100a-d. Finally, it is conceivable that a phase element 108 or another optical element is used jointly by a plurality of lighting modules 100a-d. It has to be accepted in this respect or has to be prevented by sufficient dimensioning that the interference of the plurality of light sources 104a-d result in the disturbing superimpositions of the individual patterns 20a-d which impair the contrast.

A structured illumination pattern 20 is therefore generated in the spatial zone 12 by the lighting unit 100 in a very simple manner overall and the detection capability of the safety camera 10 is thus ensured. The simple structure with a laser light source 104, an optical system 106 and phase elements 108, particularly when made as a simple glass plate, manages without any complex optical systems or microstructured surfaces such as would be required, for example, for a DOE. The structure is thus extremely cost-effective and compact. For this reason, embodiments with a plurality of lighting modules such as in accordance with FIG. 5 can also be used for practical use and with an acceptable effort.

The arising structured illumination 20 serves not only for the contrast increase in safety cameras, but also for general monitoring tasks. It shows particular benefits, however, in connection with stereo spatial image-taking processes. The arising dense depth maps can in turn be used in other applications such as in automation engineering; they are particularly suited for safety technology where reliable evaluations form a requirement of practical use.

Even if the different optical elements have been described separately in FIGS. 2-5, the features can also be combined differently. For example, optical elements disposed before or after the phase element 108 can thus be used in the same manner in each case largely independently of the embodiment of the phase element, can make settings of sample size and of the illuminated field in an analog manner, and the material and the structure of the phase elements 108 themselves, in particular of the surfaces generating phase differences, are respectively replaceable.

1. A lighting unit (100) having a divergent coherent light source (104, 106) for the generation of an at least locally irregular pattern (20) in a monitored zone (12), wherein the lighting unit (100) has an optical phase element (108, 110) in the beam path of a light beam from the light source (104, 106), said optical phase element having unevenness made to generate local phase differences between portions of the light beam incident at the phase element at adjacent positions and thus to generate the irregular pattern (20) by interference.

2. A lighting unit (100) in accordance with claim 1, wherein the unevenness is provided at least over the total region of the phase element (108, 110) illuminated by the light source (104, 106); and/or wherein the phase element (108, 110) has no smooth sub-regions.

3. A lighting unit (100) in accordance with claim 1, wherein the unevenness is irregular and very small with respect to the geometrical extent of the phase element (108, 110), in particular its thickness; and/or wherein the unevenness varies over the phase element (108, 110); and/or wherein the unevenness is provided on one or more surfaces of the phase element (108, 110).

4. A lighting unit (100) in accordance with claim 1, wherein the phase element (108, 110) has transmissive or reflective properties, is in particular a phase plate (108) or a phase mirror (110); and/or wherein the phase element (108, 110) has additional beam-shaping properties, is in particular made as a lens or as a concave mirror.

5. A lighting unit (100) in accordance with claim 1, wherein at least one further optical element (112), in particular a prism, a plate, a lens or a mirror, is arranged in the optical beam path of the phase element (108, 110), with the further element being made as a further phase element in particular by means of unevenness; and/or wherein a diaphragm or an additional optical element, in particular a cylindrical lens, is provided to specify the region illuminated by the pattern.

6. A lighting unit (100) in accordance with claim 1, wherein the phase element (108, 110) comprises glass or plastic, in particular a glass plate, a molded plastic part or a film; and/or wherein the phase element (108, 110) is coated on at least one surface or has a film, with the coating, the film or their connection region with the phase element (108, 110) having the unevenness generating local phase differences.

7. A lighting unit (100) in accordance with claim 1, wherein the light source is a laser (104); and wherein an optical distribution system (106) which can make the laser light divergent is provided between the laser (104) and the phase element (108, 110).

8. An arrangement of a plurality of lighting units (100a-d), each said lighting unit having a divergent coherent light source (104, 106) for the generation of an at least locally irregular pattern (20) in a monitored zone (12), wherein the lighting unit (100) has an optical phase element (108, 110) in the beam path of a light beam from the light source (104, 106), said optical phase element having unevenness made to generate local phase differences between portions of the light beam incident at the phase element at adjacent positions and thus to generate the irregular pattern (20) by interference, each said lighting unit being adapted for the illumination of a respective region and the arrangement being adapted for the generation of an irregular pattern (20) in an illuminated region larger than a said respective region, wherein the illuminated regions (20a-d) of the individual lighting units (100a-d) are added together in one of an overlapping and a non-overlapping manner to form said larger illuminated region.

9. An arrangement of a plurality of lighting units (100a-d), each said lighting unit having a divergent coherent light source (104, 106) for the generation of an at least locally irregular pattern (20) in a monitored zone (12), wherein the lighting unit (100) has an optical phase element (108, 110) in the beam path of a light beam from the light source (104, 106), said optical phase element having unevenness made to generate local phase differences between portions of the light beam incident at the phase element at adjacent positions and thus to generate the irregular pattern (20) by interference, each said lighting unit being adapted for the illumination of a respective region with a respective illumination intensity and the arrangement being adapted for the generation of an irregular pattern (20) in an illuminated region with an illumination intensity greater than said respective illumination intensity.

10. A safety camera (10), there being at least one lighting unit (100) having a divergent coherent light source (104, 106) for the generation of an at least locally irregular pattern (20) in a monitored zone (12), wherein the lighting unit (100) has an optical phase element (108, 110) in the beam path of a light beam from the light source (104, 106), said optical phase element having unevenness made to generate local phase differences between portions of the light beam incident at the phase element at adjacent positions and thus to generate the irregular pattern (20) by interference.

11. A safety camera (10) in accordance with claim 10, wherein an evaluation unit (22) is provided which is made for the use of a stereo algorithm in which mutually associated partial regions of the images taken by the two cameras (14a-b, 16a-b) of the stereo camera (10) are recognized and their distance is calculated with reference to the disparity; and wherein the evaluation unit (22) is in particular furthermore configured to recognize unpermitted intrusions into the monitored zone (12) and thereupon to generate a switching-off signal.

12. A safety camera (10) in accordance with claim 10, wherein a safety output (26) is provided via which the safety camera (10) can output a switch-off signal to a monitored machine.

13. A safety camera (10) in accordance with claim 10 and in the form of a 3D stereo safety camera.

14. A method for the illumination of a monitored zone (12) having an at least locally irregular pattern (20), wherein said pattern (20) is generated in that divergent coherent light is radiated onto a phase element (108, 110) having unevenness; and wherein said unevenness of the phase element (108, 110) generates local phase differences between portions of the coherent light incident at the phase element (108, 110) at adjacent positions and thus generates irregular patterns (20) by interference.

15. A method in accordance with claim 14, wherein the structural size of the pattern (20) is set by the distance between a source (104, 106) of the divergent coherent light and the phase element (108, 110).

16. A method I accordance with claim 15, wherein the illuminated region is set by means of at least one optical element.

17. A method in accordance with claim 16, wherein said at least one optical element is selected from the group comprising a prism, a plate, a lens, a mirror, a diaphragm and a cylindrical lens or a combination thereof.

18. A method in accordance with claim 15, wherein a plurality of sources (100a-d, 104a-d) for divergent coherent light are used to generate a larger illuminated region.

19. A stereoscopic image detection method for the generation of a dense depth map of a scene in a monitored zone (12), wherein the monitored zone (12) is illuminated by an at least locally irregular pattern (20),), wherein said pattern (20) is generated in that divergent coherent light is radiated onto a phase element (108, 110) having unevenness; and wherein said unevenness of the phase element (108, 110) generates local phase differences between portions of said coherent light incident at the phase element (108, 110) at adjacent positions and thus generates irregular patterns (20) by interference.

20. A method for the safe three-dimensional monitoring of a spatial zone (12), in which a dense depth map of a scene in a monitored zone is generated, wherein the monitored zone (12) is illuminated by an at least locally irregular pattern (20),), wherein said pattern (20) is generated in that divergent coherent light is radiated onto a phase element (108, 110) having unevenness; and wherein said unevenness of the phase element (108, 110) generates local phase differences between portions of said coherent light incident at the phase element (108, 110) at adjacent positions and thus generates irregular patterns (20) by interference and wherein the dense depth map is evaluated for unpermitted intrusions and, if an unpermitted intrusion is recognized, a switch-off signal is output to a danger source.
